(19) United States
(12) Patent Application Publication
(10) Pub. No.: US 2026/0155581 A1
(43) Pub. Date: Jun. 4, 2026

(54) AN ANTENNA STRUCTURE

(71) Applicant: SIGNIFY HOLDING B.V., EINDHOVEN (NL)

(72) Inventors: YUE HE, SHANGHAI (CN); RUIPAN ZHANG, SHANGHAI (CN); CHAONAN TIAN, SHANGHAI (CN); YONGJUN YANG, SHANGHAI (CN)

(21) Appl. No.: 19/111,472

(22) PCT Filed: Sep. 5, 2023
(86) PCT No.: PCT/EP2023/074248

§ 371 Date: Mar. 13, 2025

(30) Foreign Application Priority Data
Sep. 16, 2022 (WO) PCT/CN2022/119290
Nov. 4, 2022 (EP) 22205461.1

(51) Int. Cl. H01Q 15/14; H01Q 9/16; H01Q 9/30

(52) U.S. Cl. CPC H01Q 15/14; H01Q 9/16; H01Q 9/30

(57) ABSTRACT

An antenna structure for radiating a radiofrequency signal. The antenna structure comprises a conductive element having a rim with a rim edge and a gap. A wire antenna element is positioned to partially overlap the rim by extending in parallel with the rim edge and partially overlap the gap. The rim edge is, in an assembled and ready to operate state of the antenna structure, electromagnetically exposed and the wire antenna element is configured such that a radiofrequency current induced or flowing through the wire antenna element induces an electric field in the overlapped portion of the rim and the edges of the gap, causing the overlapped electromagnetically exposed rim edge of the portion of the rim and the edges of the gap to radiate the radiofrequency signal responsive to the radiofrequency current.

### FIELD OF THE INVENTION

The present invention relates to the field of antenna design.

### BACKGROUND OF THE INVENTION

Antenna structures are widely used in the field of radiofrequency communication, in order to radiate and receive radiofrequency signals. In particular, antenna structures are commonly used to allow a transceiver to communicate with other devices having an antenna structure.

There is an increasing interest in the development of compact antenna structures, such as those that can fit within the housing or casing of a luminaire. There is a significant challenge in such use-case scenarios, as the presence of the housing or casing, as well as any conductive elements inherent to such devices (e.g., heat sinks or heat spreaders), can significantly affect the efficiency of the antennas structure.

A standard radiofrequency (RF) board with a Planar Inverted-F antenna (PIFA) antenna printed on the board has been widely used in the industry. But such RF boards are unable to fit into the housing of a small lamp such as MR16 lamp. Another drawback for using such standard RF boards in a lamp is that the metal housing/heatsink of the lamp, as well as external metal part of a luminaire, would interfere with the RF performance of the antenna.

It is also known to cut a slot on a heat sink of a lamp, which slot has a length corresponding to half or one quarter lambda (λ) of the desired/target RF signal, and placing a RF radiator in the heat sink and near the slot so as to induce an electrical field on the slot causing the slot to emit the RF emission externally. Lambda (λ) represents the wavelength of the desired RF signal. This requires a large heat sink to form the slot, and the slot may negatively influence the heat dissipation of the heat sink.

There is therefore a desire for a design of an antenna structure that can perform at a high efficiency within a confined space and surrounded by those blocking elements that are present in a lamp.
US20160183353A1 discloses a light bulb with an aperture antenna.
US20160072176A1 discloses a light bulb with a slot antenna.

### SUMMARY OF THE INVENTION

The invention is defined by the claims.

The proposed invention overcomes the abovementioned problems by using a conductive element to supplement a wire antenna element to improve the radiation of a radiofrequency signal. In particular, it has been recognized that positioning the wire antenna element close to a rim of a conductive element, and configuring the rim to provide a slot or gap such that the wire antenna also at least partially overlaps this slot or gap, causes the rim, including the gap, of the conductive element to radiate the radiofrequency signal. The efficiency of such an antenna structure is much higher than a simple wire antenna element alone, particularly if the antenna structure is also surrounded by a housing/casing.

The gap is formed in the edge of the rim, e.g., to effectively be a cut-out or indentation from the edge of the rim. The gap effectively enlarges the contour length of the rim (e.g., the total length or size of the edge) on which the wire antenna induces the electric field such that the conductive element can use two dimensions to provide the necessary length, e.g., corresponding to half or quarter lambda (λ). Therefore the proposed invention can fit into small size applications or devices such as lamp.

The conductive element can, for instance, be an existing conductive element inherent to the electronic device-such as a heat sink or heat spreader of the electronic device. This allows for existing elements or features to be repurposed for performing a secondary function, thereby improving the efficiency of the antenna structure without significantly impacting on the existing functionality of the electronic device containing the antenna structure and/or requiring additional components (and therefore additional material cost). Even more, since the gap only form a part of the length, its depth could be reduced with respect to the pure slot antenna. Thus, the proposed embodiment would not significantly influence the heat dissipation capability of the heat sink.

According to examples in accordance with an aspect of the invention, there is provided an antenna structure comprising: a conductive component with a rim comprising a first rim portion with a rim edge and a gap neighboring the first rim portion; and a wire radiation element, electrically isolated from the conductive component, comprising: a first wire part spatially aligned with and extending in parallel with the rim edge of the first rim portion; and a second wire part spanning over a portion of the gap. The rim edge is, in an assembled and ready to operate state of the antenna structure, electromagnetically exposed and the wire radiation element is configured to, when fed with a radiofrequency current, induce an electric field within the first rim portion and edges of the gap, causing the electromagnetically exposed rim edge of the first rim portion and the edges of the gap to radiate a radiofrequency signal responsive to the radiofrequency current fed in the wire radiation element.

In the proposed approach, the gap on the conductive element is designed such that the portion of the conductive element in the vicinity of the gap (including at least the first rim portion) becomes the main radiator of the antenna. This acts to decouple the radiation location away from the wire antenna element, and can thereby distance the radiation location from a casing or housing of the antenna structure.

Inducing an electric field in the first rim portion and the gap effectively induces a current flow across the surface of the first rim portion and the bounds of the conductive element at the gap. This induced surface current causes these elements to radiate energy in the form of electromagnetic waves (i.e., the radiofrequency signal).

Contrary to the known applications wherein the antenna is put below the conductive element (heatsink) and blocked by the conducive element, the present application effectively uses the rim of the conductive element as the antenna, and the efficiency of the proposed antenna structure is markedly higher and less sensitive to the conductive element. The conductive element can also be used for other functions, such as heat spreading, thereby facilitating a more compact electronic device.

In some examples, the length of the wire radiation element aligned with and extending in parallel with the rim edge plus the contour length of the gap corresponds to a desired wavelength of the radiofrequency signal, and preferably wherein the length of the wire radiation element aligned with and extending in parallel with the rim edge plus the contour length of the gap is equal to half of the desired wavelength of the radiofrequency signal.

The contour length of the gap is the total length along the sides of the gap, which are also induced with an electric field by the antenna and thereby contribute to the portion of the rim that generates or emits the radiofrequency signal.

In this embodiment, not only span dimension of the gap, but also the depth dimension of the gap can be used to be induced with electric field and effectively contribute to emit the RF signal, thus a small conductive element can provide the sufficient antenna length.

Put another way, the effective length of the edge of the rim in which an electrical field is induced by the wire antenna element (causing the rim to act as a radiating element) is effectively increased by the introduction of a gap or cut within the rim and the positioning of the wire antenna to at least partially overlap this gap. The edges of the rim thereby act to increase the effective length of the rim that radiates the radiofrequency signal to facilitate provision of an antenna within a smaller volume, and which has been evidenced to be less sensitive to the presence of any potential blocking element. Thus, the effective radiation length of the rim, being the length of the edges of the rim that radiate the radiofrequency signal is increased.

The gap may form a gap, split or spacing between two rim portions.

In some embodiments, the length of the wire radiation element aligned with and extending in parallel with the rim edge is between 7.5 to 50 mm, preferably between 7.5 to 45 mm, and even preferably between 7.5 to 32.5 mm. These embodiments provide preferred implementation of the wire radiation element for good RF performance.

Optionally, the rim comprises a second rim portion, the gap is formed as an air gap between the first rim portion and the second rim portion; the wire radiation element further comprises a third wire part spatially aligned with and extending in parallel with the rim edge of the second rim portion; and the length of the rim edges of the first and second rim portions plus the contour length of the gap corresponds to a desired wavelength of the radiofrequency signal.

This embodiment provides a symmetrical antenna structure.

In some examples, the wire radiation element comprises a dipole antenna arrangement comprising: a first conducting element comprising the first wire part and a first portion of the second wire part, and being configured such that a radiofrequency current in the first conducting element induces a non-negligible electric field in the first rim portion and a first portion of the gap; and a second conducting element orientated from the first conducting element by 180°, comprising the third wire part and a second portion of the second wire portion and being configured such that a radiofrequency current in the second conducting element induces a non-negligible electric field in the second rim portion and a second portion of the gap.

A dipole antenna arrangement provides a materially efficient approach to providing an antenna structure that can be readily configured and appropriately positioned with respect to a gap to achieve good radiation efficiency of the overall antenna structure.

The dipole antenna arrangement may exhibit reflection symmetry, wherein an axis of reflection of the dipole antenna arrangement is positioned to be spatially aligned with the gap and equidistant from the first rim portion and the second rim portion. This approach evenly spreads an induced electric field in the conductive element across portions located on both sides of the gap, which provides a uniform radiation pattern for the emitted radiofrequency signal.

In some examples, the dipole antenna arrangement comprises a pair of feed-in points at the axis of reflection of the dipole antenna arrangement. This results in the feed-in points being located within the gap of the conductive element, resulting in improved performance of the antenna structure.

The present application is not limited as the above described symmetrical antenna, but could also be asymmetrical (e.g., a monopole antenna). The wire radiation element may be a monopole antenna with a feed-in point at one end of the wire radiation element.

In some examples, a distance between the wire radiation element and the rim edge of the first rim portion is between 0.5 mm and 3 mm. This approach ensures a close electrical coupling between the wire radiation element and the first rim portion as well as the gap, to improve the flow of electricity through the first rim portion and through the gap, and thereby the radiation of electromagnetic waves by the first rim portion and the gap.

The gap may be rectangular, trapezoidal, or triangular shape.

Those shapes effectively provide substantial depth of the gap to contribute to the antenna length. Also, the conductive element can be easily processed, such as being stamped, to have those shapes.

In some examples, e.g., when the gap is rectangular shape, the span of the gap is between 10 mm and 15 mm.

The vertical height or depth of the gap, being perpendicular to the span, is between 10 mm and 20 mm.

Those dimensions are suitable for providing an antenna length of a popular 2.4 GHz RF antenna, such as WiFi, ZigBee or Bluetooth. Alternatively, those dimensions can be changed to correspond to antenna length of cellular frequency band.

The antenna structure may further comprise a substrate, wherein the wire radiation element is on the substrate, e.g., coupled to the substrate. The conductive component may be fixed to the substrate such that the first wire part of the wire radiation element and the rim edge of the first rim portion are spatially aligned with each other and extending in parallel with each other. Positioning the wire radiation element on the substrate can provide reliable positioning of the wire radiation element (with respect to the conducive element), whilst remaining easy and efficient to manufacture or assemble.

The substrate may comprise a housing containing and holding the conductive component.

This embodiment provides a compact design for an appliance which definitely has a housing.

The antenna structure may comprise a RF circuit board contained in the housing and including RF circuitry. The RF circuitry may be configured to generate the radiofrequency signal for controlling the radiofrequency signal. Since the RF circuit board does not contain the antenna, it could be relatively small and fit into the housing. This provides a more compact structure compared to existing antenna structures or devices containing such antenna structures.

The antenna structure may comprise at least one feed-in element formed on the housing and electrically connected to the wire radiation element. The feed-in element(s) thereby provide(s) the radiofrequency current (e.g., generated by the RF circuitry) to the wire radiation element. The feed-in elements can be arranged to overlap the gap in the conductive element, but this is not essential as the feed-in element does not directly induce the electrical field on the conductive element.

The antenna structure may comprise at least one connector connecting the feed-in element and the RF circuitry.

The connector can be implemented in various manners such as direct coupling by pogo pin and welding, as well as indirect coupling by capacitive coupling.

The at least one feed-in element may comprise a transmission line, electrically connected to the wire radiation element, adapted to perform impedance matching. Since a wire radiation element is used to induce the electric field on the gap besides the rim portion, its impedance may need to be matched by using a transmission line.

In some examples, the conductive component is plate-shaped. The housing may be cup or cylinder shaped and comprise an opening conformal to the rim of the conductive component for receiving said plate-shaped conductive component; and, optionally, the wire radiation element is positioned along the opening of the housing, such that the wire radiation element is conformal thereby aligning with the rim of the conductive element. Preferably, the conductive component is a heat spreader or a heat sink. This embodiment recognizes that the conductive component can perform a dual purpose of contributing to the emission/radiation of the radiofrequency signal as well as performing another function of heat spreading/sinking. In particular, it is possible to use an existing heat spreader/sink, or design therefor, to also perform radiation of the radiofrequency signal.

There is also proposed an LED lighting apparatus (e.g., a lamp or bulb) comprising the antenna structure previously described (wherein the conductive component is a heat spreader); and an LED lighting unit, placed on and thermally coupled to the heat spreader.

There is also proposed an electronic device comprising the antenna structure previously described and a metal casing that at least partially encloses or surrounds the antenna structure.

The electronic device may be an LED lighting apparatus, e.g., a lamp or bulb, that further comprises an LED lighting unit.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates an antenna structure according to an embodiment;

FIG. 2 provides another view of the antenna structure;

FIG. 3 illustrates induced currents and/or electric fields in the antenna structure;

FIG. 4 illustrates additional optional features of the antenna structure;

FIG. 5 illustrates an electronic device comprising a proposed antenna structure;

FIG. 6 illustrates the efficiency of the proposed antenna structure;

FIGS. 7 and 8 illustrate the farfield radiation pattern for the proposed antenna structure;

FIG. 9 illustrates a simulated electric current in the antenna structure;

FIG. 10 illustrates a first monopole antenna structure;

FIG. 11 illustrates a second monopole antenna structure;

FIG. 12 illustrates the efficiency of the monopole antenna structures;

FIGS. 13 and 14 illustrate the farfield radiation pattern for the first monopole antenna structure;

FIGS. 15 and 16 illustrate the farfield radiation pattern for the second monopole antenna structure;

FIG. 17 illustrates an antenna structure having a ring antenna; and

FIG. 18 illustrates a simulated electric current in the antenna structure having the ring antenna.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides an antenna structure for radiating a radiofrequency signal. The antenna structure comprises a conductive element having a rim defining a gap. A wire antenna element is positioned to partially overlap the rim and partially overlap the gap. The wire antenna element is configured such that a radiofrequency current induced or flowing through the wire antenna element induces an electric field in the overlapped portion of the rim and the edges of the gap, causing the overlapped portion of the rim and the edges of the gap to radiate the radiofrequency signal responsive to the radiofrequency current.

Proposed embodiments can be used in any device or product that desires an antenna structure. However, the advantages of the proposed embodiments are particularly marked or prevalent when the antenna structure is surrounded or encircled by a metal casing, e.g., as is relatively commonly in lamps or lighting devices. In particular, unlike existing antenna structures, the efficiency of the proposed antenna structure has a reduced loss in efficiency when surrounded or encircled by a metal casing, compared to existing antenna structures.

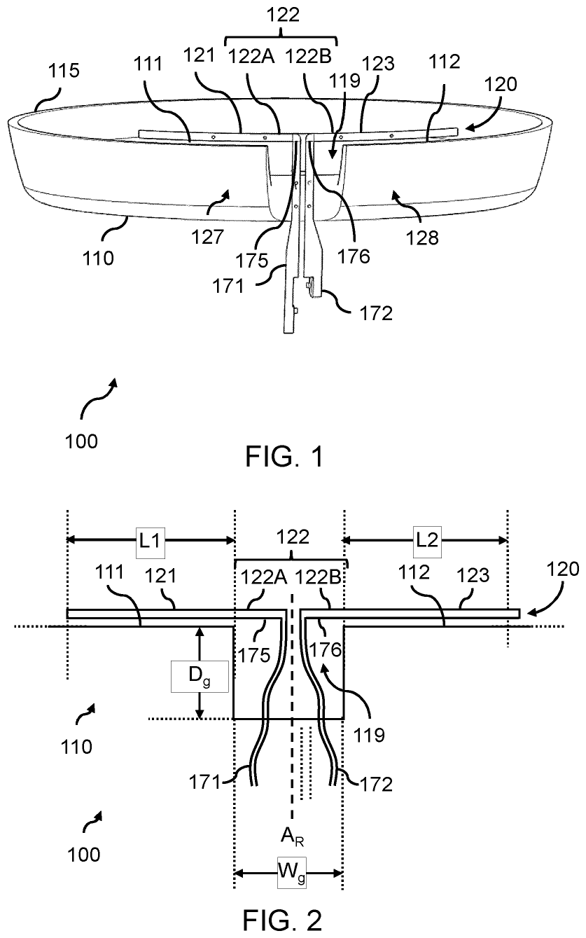

FIG. 1 conceptually illustrates an antenna structure 100 according to an embodiment. The antenna structure comprises a conductive element 110 and a wire radiation element 120.

The conductive element 110 is formed of a conductive material, particularly an electrically and/or heat conductive material such as a metal. Example metals include aluminum, copper, steel, iron and so on. The conductive element 110 may be a heat spreader for an electronic device, such as a lighting apparatus or lamp.

The conductive component 110 comprises a rim 115. The rim is formed from at least a first rim portion 111 and a gap 119 that neighbors the first rim portion. In a preferred embodiment, the rim may, for instance, be formed from a first rim portion 111 and a second rim portion 112 that are separated by the gap 119. For instance, the gap 119 may be formed as an air gap between the first rim portion 111 and the second rim portion 112. In this way, the gap 119 can be formed as a slot, slit or cut-out within the rim 115 of the conductive component 110. Alternatively, there could be electrical insulating material in the gap to “replace” the air. For example, if heat dissipation is strongly required, ceramic material may fill the gap which is able to conduct and dissipate heat well, but still leave the electrically conductive edges or contour of the gap to be induced with electric field by the wire radiation element 120.

The gap 119 may be formed in any shape, such as in a rectangular, trapezoidal, or triangular shape. In the illustrated example, the gap is in a generally rectangular shape, with somewhat round corners.

The wire radiation element 120 is electrically isolated from the conductive component 110. This can, for instance, be achieved separating them with an air gap or by a gap filled with electrically insulating material.

The wire radiation element 120 comprises at least a first wire part 121 that is spatially aligned with the first rim portion 111. The wire radiation element 110 also comprises a second wire part 122 that spans over a portion of the gap 119. Thus, in the illustrated example, the second wire part 122 is spatially aligned with and spanning over the gap 119.

In the context of the present disclosure, if a feature of the wire radiation element is spatially aligned to a feature of the conductive element, this indicates that the most proximate part of the conductive element to the feature of the wire radiation element is said feature of the conductive element.

The wire radiation element is positioned and/or configured such that, when fed with a radiofrequency current, an electric field is induced within the first rim portion and the gap. This electric field causes the first rim portion and the gap to radiate a radiofrequency signal responsive to the radiofrequency current fed in the wire radiation element.

More particularly, the electric field causes a surface current to be induced along an outermost edge of the rim 115, including the first rim portion 111 and the edges of the gap 119. This surface current distribution effectively activates/configures the rim (particularly in the regions adjacent to the wire radiation element) as a radiator of the radiofrequency signal. More particularly, the bounds of rim 115 including the first rim portion 111 and the edges of the gap 119 near the wire radiation element will radiate the radiofrequency signal.

Put yet another way, the radiofrequency current through the wire radiation element 120 is coupled to the first rim portion 111 and the edges of the gap 119 of the conductive component 110. In particular, a current is induced on the conductive element. The positioning of the wire radiation element is such that the rim portion and the edges of the gap of the conductive component is stimulated.

In this way, the rim 115 including the rim portion 111 and the gap 119 of the conductive component 110 contributes to the radiation of a radiofrequency signal. This enhances the radiation performance of the overall antenna structure, beyond that previously possible using just the wire radiation element alone or using a slot antenna located on the conductive component alone. Even more, the depth of the gap is also used to emit the radiofrequency signal (i.e., the edges of the gap that stretch in the depth direction). Thus, the desired antenna length can be obtained with a smaller total span of the gap/perimeter of the rim 115, making the conductive element smaller and suitable for small applications.

The radiofrequency signal is an emission or radiation of electromagnetic waves at a radiofrequency. The frequency of the emitted electromagnetic waves is dependent upon the effective length of the rim that has been induced with electric field, in this case is the length of the rim portion plus the contour/edge length of the gap which comprises two times of the depth plus a span width of the gap. Other factors may influence the precise frequency of the radiofrequency signal emitted by the first rim portion and the gap, a number of which are later described.

The conductive element can perform a dual duty of aiding in the radiation of a radiofrequency signal and performing other conductive functions, such as heat spreading or heat dissipation.

Another advantage of the proposed approach is that good antenna performance can be achieved whilst closely positioning the wire antenna element 120 to the conductive element 110. This means that a more compact device (comprising the proposed antenna structure 100) can be provided or produced.

The shape of the wire antenna element 120 may match or correspond to the shape of the rim 115 of the conductive element 120. Thus, the shape of the wire antenna element may geometrically match the shape of the rim 115 of the conductive element 120. This improves the coupling between the wire antenna element and the conductive element, to thereby improve the efficiency of the antenna structure.

In preferred examples, the length of the first rim portion 111 plus the contour length of the gap 119 corresponds to a desired wavelength of the radiofrequency signal. The contour length of the gap 119 is a total length of the edges of the gap in which an electrical current is induced by the wire antenna element 120 in the conductive element. For the illustrated wire radiation element, this comprises two times the depth of the gap plus a span width of the gap, as an electrical field is induced along all the edges of the gap by the antenna element 120 when conducting electricity.

In the illustrated example, the wire radiation element 120 is formed as a dipole antenna arrangement.

This dipole antenna arrangement comprises a first conducting element 127, formed of the first wire part 121 and a first portion 122A of the second wire part 122. In this way, a radiofrequency current in the first conducting element induces a non-negligible electric field in the first rim portion 111 and a first portion of the gap.

This dipole antenna arrangement also comprises a second conducting element, formed of a third wire part 123 (spatially aligned with the second rim portion 112) and a second portion 122B of the second wire part. In this way, a radiofrequency current in the second conducting element induces a non-negligible electric field in the second rim portion and a second portion of the gap.

The second conducting element 128 is oriented from the first conducting element 127 by 180°. Thus, the second conducting element 128 is directed or points in an opposite direction to the first conducting element 127.

In some examples, the antenna structure 100 may further comprise a pair of feed-in elements 171, 172. The feed-in elements are configured to carry the radiofrequency current to the wire radiation element 120. Thus, feed-in elements 171, 172 may provide the electrical connection to a radiofrequency generator (not shown) for driving the antenna structure.

In the illustrated examples, the feed-in elements are positioned to overlap the gap 119 of the conductive element 110. The feed-in element extends from the bottom of the gap 119 to the top of the gap and contacts the wire at the top. However, the feed-in element do not actively induce the electric field on the rim portion or the (edges of the) gap. In an alternative embodiment, the feed-in element can be orientated by 90 degree and is in the plane of the rim 115.

The feed-in elements 171, 172 connect to the dipole antenna arrangement 120 at feed-in points 175, 176. In the illustrated example, the feed-in points comprise a first feed-in point for the first portion 122A of the second wire part and a second feed-in point for the second portion 122B of the second wire part.

The distance between the feed-in points 175, 176 changes or modifies the bandwidth of the antenna structure. Thus, it is possible to tune the bandwidth of the antenna structure by defining or setting the distance between the feed-in points 175, 176.

The resonant frequency of the antenna structure is at least partially defined by the length of the wire antenna element. Thus, defining or modifying the length of the wire antenna element can be used to define or modify the resonant frequency of the antenna structure. The resonant frequency of the antenna structure is also at least partially defined by the depth of the gap. It will be described in detail by referring to FIG. 2.

FIG. 2 conceptually illustrates the spatial relationship between the wire radiation element 120 and the conductive element 110 for the dipole antenna arrangement. In particular, it is clearly demonstrated how a portion (the second wire portion 122) of the wire antenna element is positioned to overlap the gap 119 of the conductive element 110.

Forming the wire antenna element in this configuration causes the electric field induced in the conductive element 110 to be distributed under the first rim portion 111, the two lateral edges and the bottom of the gap 119, and the second rim portion 112.

FIG. 2 also illustrates how the dipole antenna arrangement may exhibit reflection symmetry, wherein an axis of reflection A_{R} of the dipole antenna arrangement is positioned to be spatially aligned with the gap 119 and equidistant from the first rim portion 111 and the second rim portion 112.

The feed-in points 175, 176 may be positioned at the axis of reflection A_{R} of the dipole antenna arrangement 120. In other words, the feed-in points 175, 176 may be positioned more proximate to the axis of reflection A_{R} than any other part/portion of the wire radiation element 120.

FIG. 2 also illustrates a width W_{g} or span of the gap 119 and a vertical height or depth D_{g} of the gap 119. The width W_{g} is the distance across the gap, e.g., in a direction away from the first rim portion 111 or between the first and second rim portions. The depth D_{g} is a distance of the gap in a direction perpendicular to the width W_{g}.

The effective radiating length is thus the sum of the length L1 of the first wire part 121, the depth D_{g} of the gap, two halves of the width W_{g} of the gap, the depth D_{g} of the gap, and the L2 of the third wire part 123. An effective radiating length is the effective length of the edge of the rim that radiates the radiofrequency signal responsive to an electrical current through the wire antenna (as a result of the induced electrical field in the rim of the conductive element). Put mathematically, the effective radiating length L_{R} for the illustrated antenna structure can be defined by the following equation:

$${L}_{R} = L 1 + L 2 + 2 {D}_{g} + {W}_{g} \qquad ( 1 )$$

For improved/maximum efficiency, the radiating length equals half lambda of the (desired) radiofrequency signal.

The span or width Wg of the gap may be between 10 mm and 15 mm. The vertical height or depth D_{g} of the gap may be between 10 mm and 20 mm. Those dimensions make the gap suitable being part of a radiating length for a widely used 2.4 GHz radiofrequency signal.

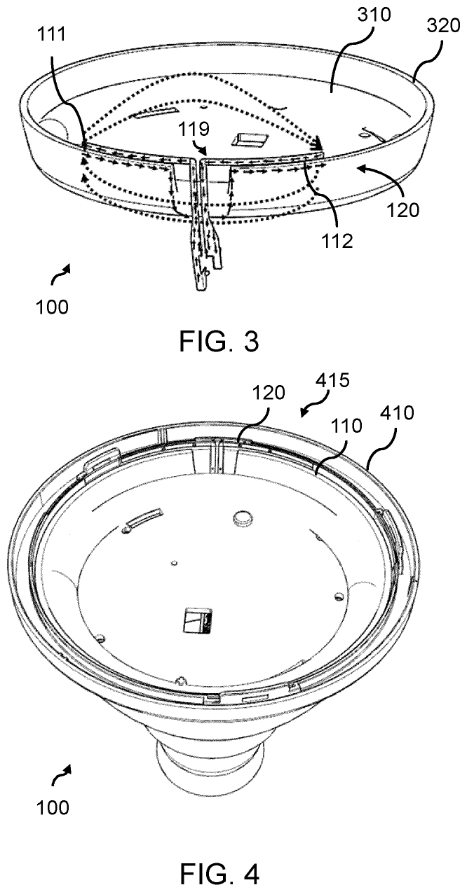

FIG. 3 illustrates the effect of feeding or providing radiofrequency current to the wire radiation element 120.

In particular, radiofrequency current (illustrated with small arrows) flowing through the wire radiation element 120 causes an electric field (illustrated with dotted arrows) to be induced within at least the first rim portion 111 and the (edges of the) gap 119. This results in the first rim portion 111 and the (edges of the) gap 119 radiating a radiofrequency signal.

Of course, for the illustrated dipole antenna arrangement, radiofrequency current flowing through the wire radiation element 120 also causes an electric field (illustrated with dotted arrows) to be induced within at least the second rim portion 112 and the edges of the gap 119. This results in the second rim portion 112 contributing to the radiating of the radiofrequency signal.

FIG. 3 also illustrates a shape of the conductive component 110 according to some examples. In particular, the conductive component may be plate-shaped. In particular, the conductive component may comprise a planar portion 310 at the bottom of the plate and a protruding portion 320 located around the edge of the planar portion 310 as the lateral edge of the plate. The protruding portion 320 may define the rim of the conductive component. The planar portion 310 may be replaced by a tapering portion (e.g., a conical portion).

FIG. 4 illustrates further optional features and configuration details for an antenna structure 100.

In particular, the antenna structure 100 may comprise a substrate 410. The wire radiation element 120 may be positioned on the substrate 410. The conductive component 110 is coupled or fixed on the substrate such that the first wire part of the wire radiation element and the first rim portion are spatially aligned.

In the illustrated example, the substrate 410 is formed as a housing. The housing contains and holds the conductive component 110. In some examples, the housing is cup or cylinder shaped, e.g., be formed as a cylinder or in a tapering structure. The housing may be formed of any suitable material, e.g., a plastic material. Preferably, the housing is formed of an electrically insulating material, such as plastic, ceramic or dielectric material.

The housing may comprise an opening 415 conformal to or sized to admit the rim of the conductive component to thereby receive the conductive component. The wire radiation element may be positioned along the opening of the housing, such that the wire radiation element is conformal therefore, thereby aligning the wire radiation element with the rim of the conductive element.

The wire radiation element 120 can be formed on the substrate using a metal-printing process or can be formed by overmolding or otherwise attaching the wire radiation element in/on the substrate 410. These techniques provide an antenna structure that can be easily fabricated.

For improved energy coupling between the wire radiation element and the conductive element, the coupling distance (i.e., the distance between the wire radiation element and the conductive element) should be relatively low, e.g., ≤5 mm or ≤3 mm. But in order to keep the clearance, e.g., to prevent/avoid arcing, preferably, the distance is no less than 0.1 mm, e.g., no less than 0.2 mm. In some preferred examples, a distance between the wire radiation element and the first rim portion is between 0.5 mm and 3 mm.

Other characteristics that will affect the impedance and resonant frequency of the antenna structure include the size of the gap and the length of the wire radiation elements (specifically, for a dipole antenna arrangement, the length of each conductive element).

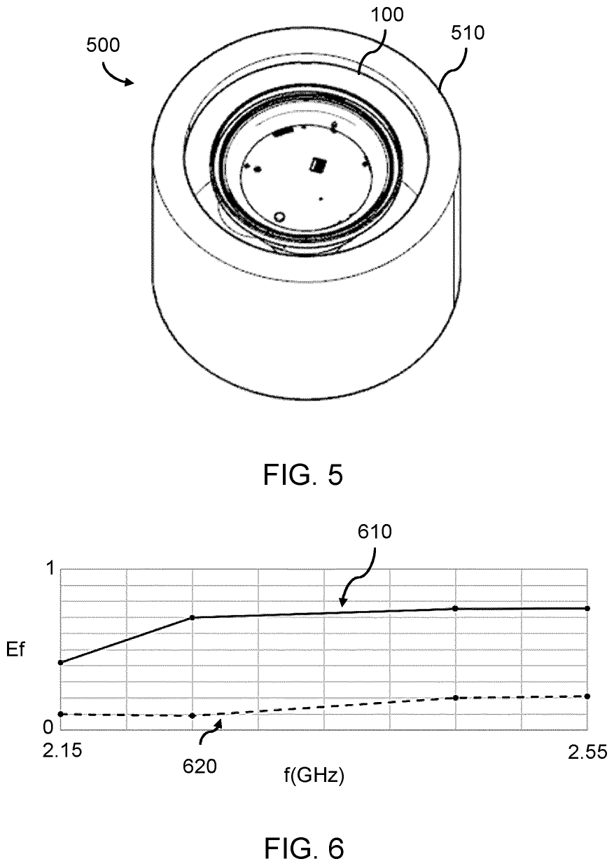

FIG. 5 illustrates a luminaire 500 or lamp with a metal casing 510 of the luminaire, the lamp with the antenna structure is mounted in the luminaire and the metal casing 510 surrounding the lamp/antenna structure. The metal casing 500 comprises an opening for exposing the antenna structure.

For fullness of disclosure, FIG. 5 illustrates the metal casing 510 surrounding the antenna structure 100. The metal casing 510 can effectively represent the housing or outer casing of a lamp/luminaire or other electronic device.

FIG. 6 is a graph, derived from experimental data on radiation efficiency, that illustrates the effect of the proposed antenna structure in the luminaire as shown in FIG. 5. In the graph, the x-axis is a frequency f (in GHz) of the radiation signal radiated by an antenna structure and the y-axis is an efficiency, measured on a scale of 0 to 1, where 1 represents complete radiation with no signal blocking and 0 represents all signal are blocked and cannot be detected externally.

A first waveform 610 illustrates the efficiency of lamp with the proposed antenna structure, e.g., as illustrated in FIGS. 1 to 4. A second waveform 620 illustrates the efficiency of a traditional lamp with a conventional or standard PIFA antenna structure put inside the housing of the lamp. In both scenarios, the lamps are put in the luminaire structure illustrated in FIG. 5, the antenna structure is surrounded by or bounded within a metal casing, and the antenna structure is positioned at a same relative position within the metal casing. It is also noted that, without the metal casing, the efficiency of both of these antenna structures is similar, around 0.81 (at 2.5 GHZ).

The difference between the first 610 and second 620 waveform clearly demonstrates the superior performance of the proposed antenna structure. In particular, the efficiency of the proposed antenna structure is much greater than a conventional antenna structure, with significantly reduced efficiency loss (<0.1) from being placed within a metal casing.

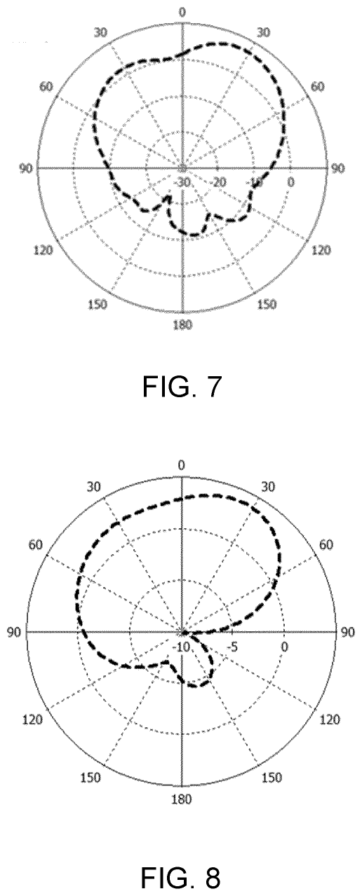

FIG. 7 illustrates the farfield radiation pattern for the antenna structure as depicted in FIG. 4 (i.e., without a metal casing). FIG. 8 illustrates the farfield radiation pattern for the electronic device as depicted in FIG. 5.

For both radiation patterns, the value of Phi is fixed at 0 and the frequency of the radiated radiofrequency signal is 2.4 GHz. The radiation power (measured in dBi) is provided for different values of Theta.

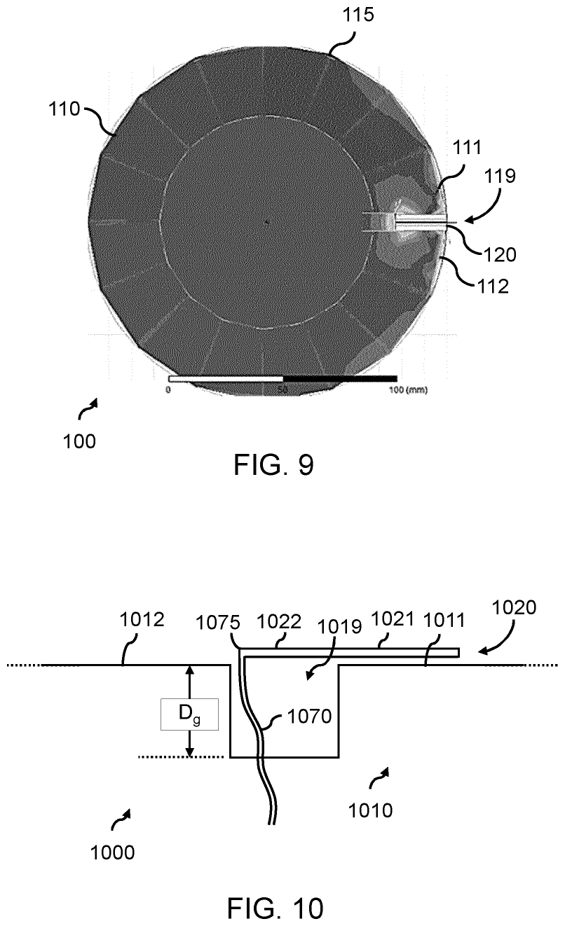

FIG. 9 is a simulation that illustrates the surface current in the conductive element 110 when an electromagnetic current is fed into the wire antenna element 120. Lighter-color areas indicate greater surface current than darker-color areas.

FIG. 9 clearly demonstrates how the surface current distribution is focused or concentrated within the first rim portion 111, the second rim portion 112 and the gap 119 (i.e., in the parts of the conductive element in the vicinity of the gap 119 or at the edges of the gap). This indicates how these areas have been activated as a radiator of electromagnetic waves (i.e., the radiofrequency signal).

In previously disclosed examples, the wire antenna element is formed as a dipole antenna arrangement. However, this configuration is not essential and the wire antenna element may instead be configured as any other suitable wire antenna element, such as a monopole antenna or a ring antenna.

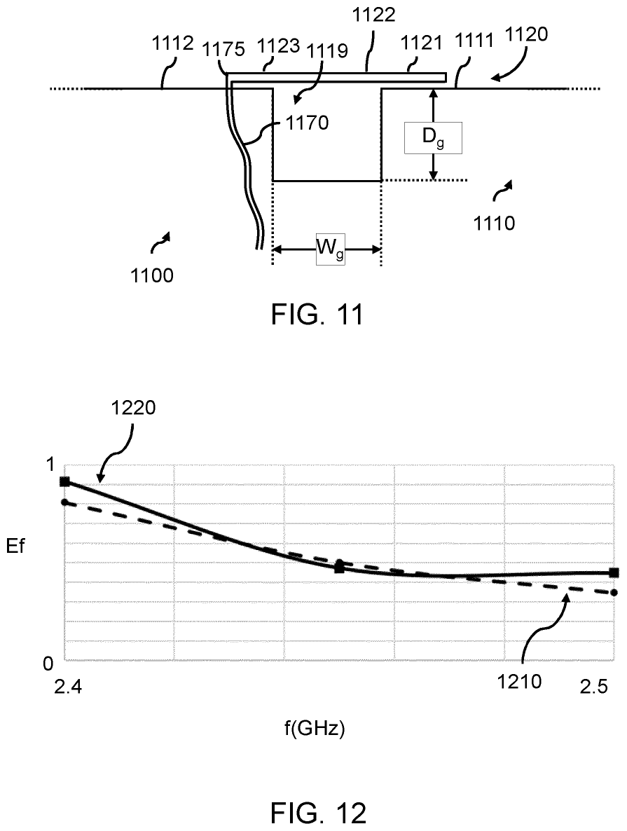

FIGS. 10 and 11 illustrates alternative embodiments in which the wire antenna element 1020, 1120 is formed as a monopole antenna. In both embodiments, the wire radiation antenna 1020, 1120 is formed as asymmetrical antenna with a single feed-in point at one end of the wire radiation antenna.

Other features of the antenna structure may be otherwise the same or equivalent to any previously described embodiment.

FIG. 10 thereby provides an illustrative representation of the spatial relationship between the conductive element 1010 and the wire radiation element 1020 of a first monopole/asymmetrical antenna structure 1000. The conductive element 1010 again comprises a first rim portion 1011 and a gap 1019.

In the illustrated example, the wire radiation element 1020 is formed a monopole antenna having a first wire part 1021 spatially aligned with the first rim portion 1011; and a second wire part 1022 spanning over a portion of the gap 1019. Here, the portion is only a part of the gap 1019.

The second wire part 1022 is connected, at a feed-in point 1075, to a single feed-in element 1070 configured to carry a radiofrequency signal to the wire antenna element 1020. Thus, the feed-in element is positioned to overlap or spatially align with the gap 1019.

The conductive element 1010 may, as illustrated, comprise a second rim portion 1012 (where the gap exists between the first and second rim portion). However, this is not essential and could instead be omitted. For instance, the second rim portion could be replaced by a non-conductive element.

For the antenna structure 1000 illustrated in FIG. 11, the effective radiation length L_{R} can be approximated using the following equation:

$${L}_{R} = {L}_{1021} + {L}_{1022} + {D}_{g} \qquad ( 2 )$$

where L₁₀₂₁ is the length of the first wire part, L₁₀₂₂ is the length of the second wire part and D_{g} is the depth of the gap.

FIG. 11 provides an illustrative representation of the spatial relationship between the conductive element 1110 and the wire radiation element 1120 of a second monopole/asymmetrical antenna structure 1100. The conductive element 1110 comprises a first rim portion 1111, a second rim portion 1112 and a gap 1119 spanning therebetween.

The wire radiation element 1120 is again formed a monopole antenna having a first wire part 1121 spatially aligned with the first rim portion 1111; a second wire part 1122 spanning over a portion of the gap 1119 and a third wire part 1123 that is spatially aligned with the second rim portion 1123.

The third wire part 1123 is connected, at a feed-in point 1175, to a single feed-in element 1170 configured to carry a radiofrequency signal to the wire antenna element 1120. Thus, the feed-in element 1175 is positioned to overlap or spatially align with the second rim portion 1123.

For the antenna structure 1100 illustrated in FIG. 11, the effective radiation length R_{L} can be defined in a similar manner to equation (1), where L1 is instead a length of the first rim portion 111 overlapped by the wire radiation element 1120 (i.e., the length of the first wire part) and L2 is instead a length of the second rim portion overlapped by the wire radiation element (i.e., the length of the second wire part).

FIG. 12 is a graph, derived from experimental data on radiation efficiency, that illustrates the effect of the proposed antenna structure in the luminaire as shown in FIGS. 10 and 11.

In the graph, the x-axis is a frequency f (in GHz) of the radiation signal radiated by an antenna structure and the y-axis is an efficiency Ef, measured on a scale of 0 to 1, where 1 represents complete radiation with no signal blocking and 0 represents all signal are blocked and can not be detected externally.

A third waveform 1210 illustrates the efficiency of a lamp with the antenna structure as illustrated in FIG. 10. A fourth waveform 1220 illustrates the efficiency of a lamp with the antenna structure as illustrated in FIG. 10.

FIG. 12 demonstrates how the monopole antenna illustrated by FIG. 10 is able to radiate 47% energy from feeding point (i.e., have an efficiency of 0.47) at 2.45 GHZ, which is significantly larger than that of the PIFA antenna (as illustrated in FIG. 6). FIG. 12 also demonstrates how the monopole antenna illustrated by FIG. 11 is able to radiate around 50% of energy provided to the feeding point (i.e., have an efficiency of 0.5) at 2.45 GHz.

Such high efficiencies ensure stable radiation of energy and stable connection of a device that communicates using such energy to another device that receives such energy.

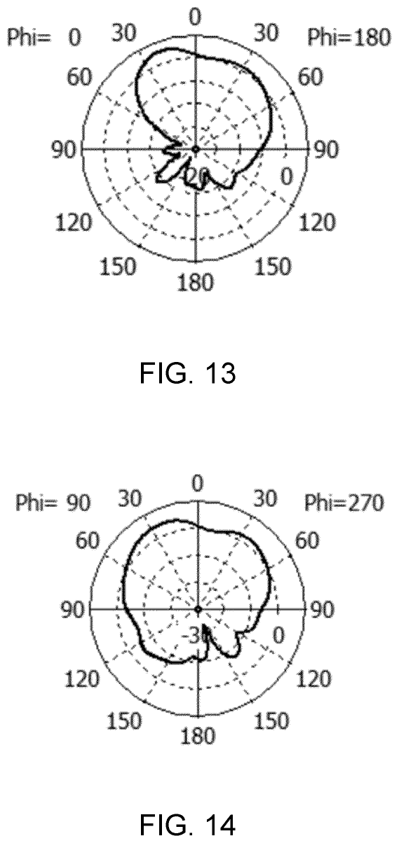

FIGS. 13 and 14 illustrate the farfield radiation pattern for the first monopole antenna structure as depicted in FIG. 10 (i.e., without a metal casing) for different values of Phi.

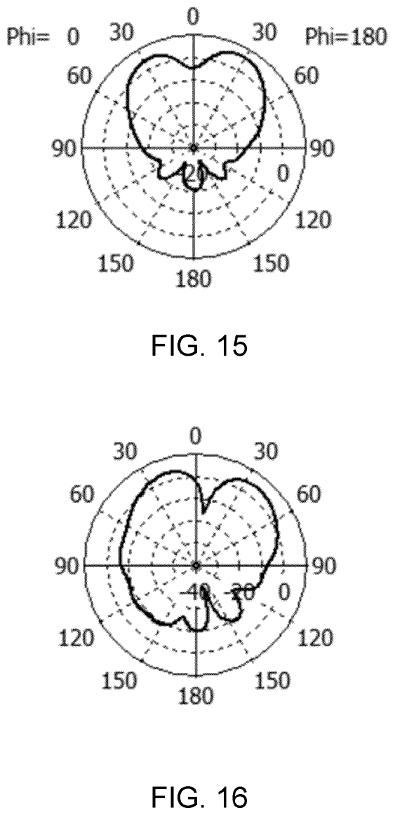

FIGS. 15 and 16 illustrates the farfield radiation pattern for the second monopole antenna structure as depicted in FIG. 11 (i.e., without a metal casing) for different values of Phi.

According to the radiation patterns of the two embodiments of monopole antenna structures, the main lobe magnitude of the two antennas is above 4 dBi. Thus, both forms of antenna (and antenna positioning) are able to act as directional antenna suitable for use in a metal housing.

Due to the symmetrical structure of the dipole antenna, the efficiency of a dipole antenna structure is a little higher than asymmetric monopole antenna (as illustrated by FIG. 6). However, the monopole antenna can be adopted to exploit the benefits of reduced material costs and/or the smaller structure. According to the radiation patterns of the two kinds of antennae, the main lobe magnitude of the two antennae is above 4 dBi, they are both directional antennae so that they can be used in the metal can/housing.

It is recognized that, due to the symmetrical structure of the dipole antenna, its efficiency at 2.45 GHz is a higher than asymmetric monopole antennae (as demonstrated by FIG. 5). However, a monopole antenna may be adapted to benefit from reduced material requirements, cost and/or space occupied by the antenna.

As previously mentioned, yet another example of a suitable wire radiation element is a ring antenna.

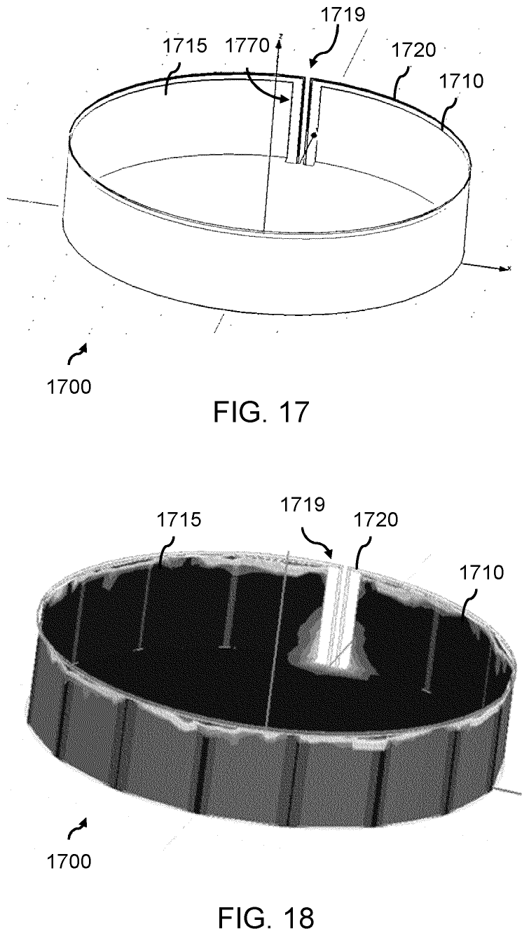

FIG. 17 illustrates an example of an antenna structure 1700 in which the wire radiation element 1720 is a ring antenna.

The ring antenna 1720 is here configured or sized to follow an (entire) edge or boundary of the rim 1715 of the conductive element 1710. This effectively causes the entire edge/boundary of the conductive element to contribute to the radiation of the radiofrequency signal when a radiofrequency current is fed to the ring antenna 1720. The ring antenna 1720 may be coupled to one or more feed-in elements 1770 that are located at the gap 1719 defined in the conductive element.

In particular, when the ring antenna is shaped and sized to follow an edge or boundary of the rim, then the followed edge of the conductive element will become the main radiator of the radiofrequency signal.

FIG. 18 is a simulation that demonstrates illustrates the surface current in the conductive element 1210 when an electromagnetic current is fed into the wire antenna element 1220 in the form of a ring antenna. Lighter areas indicate greater surface current than darker areas.

FIG. 18 clearly demonstrates how the surface current distribution is distributed across the edge or boundary of the rim of the conductive element 1210. Thus, the top edge of conductive element will become a radiator, or the main radiator, of electromagnetic waves representing the radiofrequency signal.

However, this Figure also demonstrates how the edges of the gap also contribute to the radiation of electromagnetic waves and therefore the radiofrequency signal. Thus, the effective radiation length of the overall antenna structure is increased without increased material cost.

Example dimensions for the gap have been previously described with reference to a first described embodiment, and are equally applicable to other embodiments of the present disclosure.

Other optional features of the antenna structure are hereafter described.

In some examples in which the antenna structure comprises a housing, the antenna structure comprises a RF (radiofrequency) circuit board contained in the housing and including RF circuitry. The antenna structure may further comprise a connector connecting any feed-in element of the antenna structure to the RF circuitry. The RF circuitry may be configured to control the flow of radiofrequency current to/from the wire antenna element (via the connector(s) and feed-in element).

Any feed-in element of the antenna structure may comprise or be a transmission line, electrically connected to the wire radiation element, adapted to perform impedance matching.

There is also proposed an electronic device comprising any previously described antenna structure and a metal casing that houses the antenna structure. The proposed antenna structure is particularly advantageous in such use-case scenarios, as it provides reduced sensitivity to the metal casing. The metal casing may have an opening on one side. The antenna structure may be positioned to be proximate to this opening for improved radiation efficiency.

Preferably, the distance between the metal casing and the conductive element of the antenna structure is no less than 5 mm, e.g., no less than 10 mm. This further improves the efficiency of the antenna structure.

Preferably, the distance (D1) between the wire antenna element and the conductive element is much smaller than the distance between the wire antenna element (D2) and the metal casing. Thus, D1<D2. For instance, 5.D1<D2, e.g., 10.D1<D2.

There may also be provided an LED lighting apparatus comprising the antenna structure and an LED lighting unit, placed on and thermally coupled to the conductive element. In particular, the conductive element may be a heat spreader for the LED lighting unit. The LED lighting unit may comprise one or more LEDs configured to emit light. Suitable arrangements for LED lighting units are well-established in the art.

The proposed antenna structure is particularly advantageous for use in such LED lighting apparatus, as it can configured the pattern beam of radiation output by the antenna structure to mainly face the light direction (as the heat spreader for an LED lighting unit will be positioned to align with the light direction).

The proposed antenna structure is even more advantageous if the LED lighting apparatus comprises a metal casing. This is because the heat spreader will naturally be positioned towards an opening of the metal casing (e.g., as this is the location out of which light is output) such that the pattern beam of radiation emitted by the antenna structure will be directed out of the opening in the metal casing.

TABLE 1

| | Total Radiated Power (dBm) | | |
|---|---|---|---|
| Type | 2.405 GHz | 2.440 GHz | 2.475 GHz |
| PIFA (no casing) | 4.26 | 4.37 | 4.04 |
| PIFA (with casing) | 0.6 | 0.28 | 0.71 |
| Dipole (no casing) | 8.85 | 8.76 | 8.64 |
| Dipole (with casing) | 8.28 | 8.32 | 8.18 |
| Ring (no casing) | 8.55 | 8.16 | 8.24 |
| Ring (with casing) | 7.78 | 7.52 | 7.58 |

Table 1 illustrates the particular advantage of using the proposed antenna structure when it is surrounded or encircled by a metal casing. In particular, the effect of the casing on the total radiated power (TRP) for three different types of antenna structure are indicated. The PIFA antenna structure is an existing antenna structure (e.g., that does not make use of the proposed gap-based system). The dipole and the ring antenna approaches have been previously described.

Table 1 clearly demonstrates how the loss of radiated power is significantly reduced using the proposed approach when a metal casing is introduced. Table 1 also clearly demonstrates the significant effect that a metal casing has upon the efficiency of existing antenna structures.

The present disclosure recognizes that the provision of a gap in the rim of the conductive element (and appropriately positioning of the wire antenna element) can be used to repurpose the conductive element as a radiator of the radiofrequency signal. As such, the design of the gap of the conductive element can influence the frequency of the radiofrequency signal.

In particular, the gap should be designed to ensure that the radiation frequency of the conductive element is the same as the working frequency of the wire antenna element.

Perhaps the most convenient method to design or configure the gap is to use a characteristic mode analysis technique to assess the conductive element. This can be used, for instance, to find out a mode of the conductive element at the desired frequency.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. An antenna structure comprising:
a conductive component with a rim comprising a first rim portion with a first rim edge and a gap neighboring the first rim portion; and
a wire radiation element, electrically isolated from the conductive component, comprising: a first wire part spatially aligned with and extending in parallel with the first rim edge of the first rim portion; and a second wire part spanning over a portion of the gap,
wherein the first rim edge is, in an assembled and ready to operate state of the antenna structure, electromagnetically exposed and the wire radiation element is configured to, when fed with a radiofrequency current, induce an electric field within the first rim portion and edges of the gap, causing the electromagnetically exposed first rim edge of the first rim portion and the edges of the gap to radiate a radiofrequency signal responsive to the radiofrequency current fed in the wire radiation element,
when forming a monopole antenna, the length of the wire radiation element aligned with and extending in parallel with the first rim edge plus the contour length of the gap is the effective radiation length, and
when forming a dipole antenna, the rim further comprises a second rim portion with a second rim edge, the gap is formed as an air gap between the first rim portion and the second rim portion, the wire radiation element further comprises a third wire part spatially aligned with and extending in parallel with the second rim edge, the length of the rim edges of the first and second rim portions plus the contour length of the gap is the effective radiation length.

2. The antenna structure of claim 1, wherein when forming a dipole antenna,
the length of the wire radiation element aligned with and extending in parallel with the rim edge is between 7.5 to 50 mm.

3. The antenna structure of claim 1, wherein:
when forming the dipole antenna,
said contour length of the gap comprises two times of depth of the gap plus a span width of the gap.

4. The antenna structure of claim 3, wherein when the wire radiation element is the dipole antenna comprising:
a first conducting element comprising the first wire part and a first portion of the second wire part, and being configured such that a radiofrequency current in the first conducting element induces a non-negligible electric field in the first rim portion and a first portion of the gap; and
a second conducting element orientated from the first conducting element by 180°, comprising the third wire part and a second portion of the second wire portion and being configured such that a radiofrequency current in the second conducting element induces a non-negligible electric field in the second rim portion and a second portion of the gap.

5. The antenna structure of claim 4, wherein the dipole antenna arrangement exhibits reflection symmetry, wherein:
an axis of reflection of the dipole antenna arrangement is positioned to be spatially aligned with the gap and equidistant from the first rim portion and the second rim portion; and
the dipole antenna arrangement comprises a pair of feed-in points at the axis of reflection of the dipole antenna arrangement.

6. The antenna structure of claim 1, wherein when the wire radiation element is the monopole antenna it comprise a feed-in point at one end of the wire radiation element.

7. The antenna structure of claim 1, wherein a distance between the wire radiation element and the rim edge of the first rim portion is between 0.5 mm and 3 mm.

8. The antenna structure of claim 1, wherein the gap is rectangular, trapezoidal, or triangular shape, and when the gap is rectangular shape, the span of the gap is between 10 mm and 15 mm, and
the vertical height or depth of the gap, being perpendicular to the span, is between 10 mm and 20 mm.

9. The antenna structure of claim 1, further comprising a substrate, wherein:
the wire radiation element is on the substrate; and
the conductive component is fixed to the substrate such that the first wire part of the wire radiation element and the rim edge of the first rim portion are spatially aligned with each other and extending in parallel with each other.

10. The antenna structure of claim 9, wherein the substrate comprises a housing containing and holding the conductive component.

11. The antenna structure of claim 10, further comprising:
a RF circuit board contained in the housing and including RF circuitry;
a feed-in element formed on the housing and electrically connected to the wire radiation element; and
a connector connecting the feed-in element and the RF circuitry.

12. The antenna structure of claim 11, wherein the feed-in element comprises a transmission line, electrically connected to the wire radiation element, adapted to perform impedance matching.

13. The antenna structure of claim 10, wherein:
the conductive component is plate-shaped;
the housing is cup or cylinder shaped and comprises an opening conformal to the rim of the conductive component for receiving said plate-shaped conductive component; and
the wire radiation element is positioned along the opening of the housing, such that the wire radiation element is conformal thereby aligning with the rim of the conductive element.

14. The antenna structure of claim 1, wherein the conductive component is a heat spreader.

15. An LED lighting apparatus comprising:
the antenna structure of claim 14; and
an LED lighting unit, placed on and thermally coupled to the heat spreader.
